(19) United States
(12) Patent Application Publication
(10) Pub. No.: US 2011/0243650 A1
(43) Pub. Date: Oct. 6, 2011

(54) JOINT REPLACEMENT ASSEMBLY WITH SURFACE LUBRICANT DISTRIBUTION CONFIGURATION ESTABLISHED BETWEEN BALL AND RECEIVER SQUEAKING OR ACOUSTIC EMISSIONS

(75) Inventor: Miguel A. Linares, Bloomfield Hills, MI (US)

(73) Assignee: Linares Medical Devices, LLC, Auburn Hills, MI (US)

(21) Appl. No.: 13/160,987

(22) Filed: Jun. 15, 2011

Related U.S. Application Data
(63) Continuation-in-part of application No. 12/266,695, filed on Nov. 7, 2008.
Application No. 12/266,695 is a continuation-in-part of application No. 12/411,149, filed on Mar. 25, 2009.
Application No. 12/411,149 is a continuation-in-part of application No. 12/919,242, filed on Aug. 25, 2010.
(60) Provisional application No. 61/361,101, filed on Jul. 2, 2010.
(60) Provisional application No. 60/986,486, filed on Nov. 8, 2007.
(60) Provisional application No. 61/039,612, filed on Mar. 26, 2008.

(51) Int. Cl. F16C 11/06

(52) U.S. Cl. 403/122

(57) ABSTRACT

A joint replacement assembly including a male component seating within a female component and a pattern of microgrooves defined in an articulating surface associated with at least one of the components. A volume of a lubricant is maintained in an evenly distributed fashion across the articulating surface in order to provide at least one of reduced friction, increased wear life, and elimination of squeaking or acoustical emissions. The microgrooves can exhibit any of a plurality of intersecting and enclosed profiles, a plurality of overlapping and undulating patterns, an intersecting grid pattern, and a plurality of isolated profiles. Other shapes include a concave depression cross sectional profile, each of which can further exhibit a central upward projection associated with the concave depression.

### CROSS-REFERENCE TO RELATED APPLICATIONS

This application claims the benefit of U.S. Provisional Application 61/361,101 filed on Jul. 2, 2010 and is a Continuation-in-part of application Ser. No. 12/266,695 filed on Nov. 7, 2008, which in turn claims the benefit of U.S. Provisional Application 60/986,486 filed on Nov. 8, 2007. This application is also a Continuation-in-part of application Ser. No. 12/411,149 filed on Mar. 25, 2009, which in turn claims the benefit of U.S. Provisional Application 61/039,612 filed on Mar. 26, 2008. This application is also a Continuation-in-part of application Ser. No. 12/919,242 filed on Aug. 25, 2010, which in turn claims the benefit of PCT/US2009/041627 filed Apr. 24, 2009, which in turn claims the benefit of U.S. Provisional Application 61/031,192 filed Feb. 25, 2008.

### FIELD OF THE INVENTION

The present invention relates generally to joint replacement assemblies exhibiting surface lubricant properties. More specifically, the present invention discloses a lubricant retention/distribution pattern formed along an articulating interface established between a spherical exterior surface of a male ball end portion of an artificial implant seated within an encapsulating female receiver/cup. A number of varying micro-groove or channel patterns, both overlapping as well as individually segregated, are provided in order to act as mini-dispersed reservoir locations evenly across the interfacing male ball and female receiver contact surfaces and for holding such as synovial and other naturally occurring lubricants in such a continuously coating fashion that incidences of squeaking or other acoustic emissions are avoided.

### BACKGROUND OF THE INVENTION

The prior art is documented with various types of implant joint assemblies, such typically including polished steel or like surface consistencies. Problems associated with existing artificial implants include the inevitability of surface wear or abrasion, such resulting in loss of articulating function, squeaking or other undesirable acoustic output during ambulatory function, and along with the buildup of particulates in the joint zone resulting from undesirable and non-lubricated material on material contact.

### SUMMARY OF THE INVENTION

The present invention seeks to overcome the shortcomings of the prior art and teaches a joint replacement assembly including a male component seating within a female component and a pattern of microgrooves defined in an articulating surface associated with at least one of the components. A volume of a lubricant is maintained in an evenly distributed fashion across the articulating surface in order to provide at least one of reduced friction, increased wear life, and elimination of squeaking or acoustical emissions.

The microgrooves can exhibit any of a plurality of intersecting and enclosed profiles, a plurality of overlapping and undulating patterns, an intersecting grid pattern, and a plurality of isolated profiles. Other shapes include a concave depression cross sectional profile, each of which can further exhibit a central upward projection associated with the concave depression.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a side view illustration of a first micro-groove pattern consisting of a plurality of edge communicating and non-overlapping circular channels formed on a spherical surface of a male joint implant component according to a first non-limiting variant;

FIG. 2 is a top view of the pattern illustrated in FIG. 1;

FIG. 3 is a side view illustration of a second micro-groove pattern consisting of a plurality of undulating and overlapping channels formed on a spherical surface of a male joint implant component according to a second non-limiting variant;

FIG. 4 is a top view illustration of the pattern illustrated in FIG. 3;

FIG. 5 is a side view illustration of a third micro-groove pattern consisting of a plurality of grid shaped and intersecting channels formed on a spherical surface of a male joint implant component according to a third non-limiting variant;

FIG. 6 is a top view illustration of the pattern illustrated in FIG. 5;

FIG. 7 is a top view illustration of a fourth micro-groove pattern consisting of a plurality of individually dispersed and localized circular channels formed in non-contacting fashion across a spherical surface of a male joint implant according to a fourth non-limiting variant;

FIG. 8 is a side cutaway view of an articulating interface established between a male/ball and a female/receiver within which the ball is seated; and

FIG. 9 is an enlarged partial illustration of the male/female interface depicting a cross sectional profile associated with a pair of micro-grooves for facilitating micro-dispersal of synovial lubricant.

### DETAILED DESCRIPTION OF THE PREFERRED EMBODIMENTS

As previously described, the present invention discloses a lubricant retention/distribution pattern formed along an articulating interface established between a spherical exterior surface of a male ball end portion of an artificial implant seated within an encapsulating female receiver/cup.

For purposes of ease of illustration the associated first and second joint defining bones are not illustrated however are understood to include either or both natural bones (such as in which the ball and receiver are end mounted in an in situ operation) as well as contemplating the installation of artificial bones integrating the ball and receiver components. A number of varying micro-groove or channel patterns, both overlapping as well as individually segregated, are provided in order to act as mini-dispersed reservoir locations evenly across the interfacing male ball and female receiver contact surfaces and for holding such as synovial and other naturally occurring lubricants in such a continuously coating fashion that incidences of squeaking or other acoustic emissions are avoided.

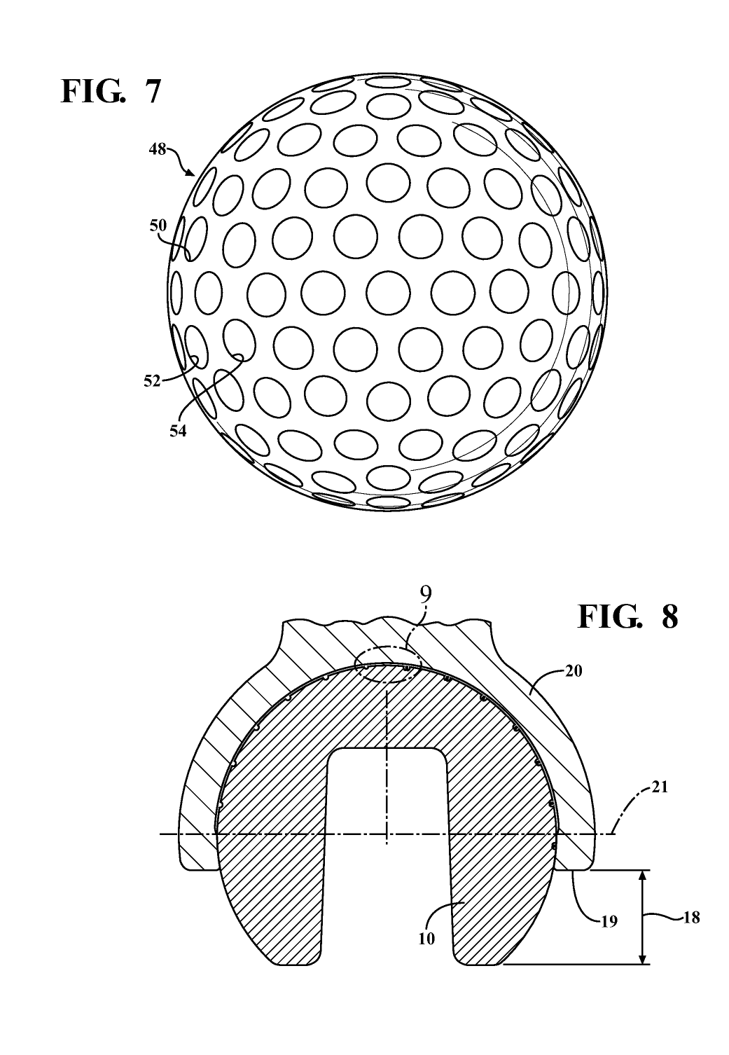

As is known, synovial fluid exhibits a viscous composition and is typically found in the cavities of articulating joints such as associated with ankle, knee, hip, elbow, wrist, and the like. With its yolk-like consistency (“synovial” partially derives from the ovum, which is Latin for egg) the principal role of synovial fluid is to reduce friction between the articular cartilage of synovial joints during movement. It is understood that, additional to naturally occurring types of synovial lubricants, other artificial or synthetically created lubricants are envisioned which can be synthesized and, then implanted (such as in a hermetically contained articulating zone established between the male ball and female receiver as is depicted in the side cutaway of FIG. 7).

Also, and beyond the embodiments depicted herein, it is further understood that the microgroove and lubricant dispersing profiles can be incorporated into either or both of male/ball and female/receiver joint components, such as mounted to reconditioned ends of first and second joint defining bones (not shown). The material construction can include any individual or composite of ceramics, plastics, and metals.

The replacement joint applications, in which the lubricant distribution patterns are incorporated, is further intended to include any mammalian type joint. It is also envisioned and understood that, outside of in situ mammalian retrofit joint applications, the lubricant distribution patterns can be likewise depicted upon any suitable articulating joint associated with any type of manufacturing assembly or mechanism (such as CNC controlled robotic arms associated with spray, welding or other reciprocating/articulating range of motion applications).

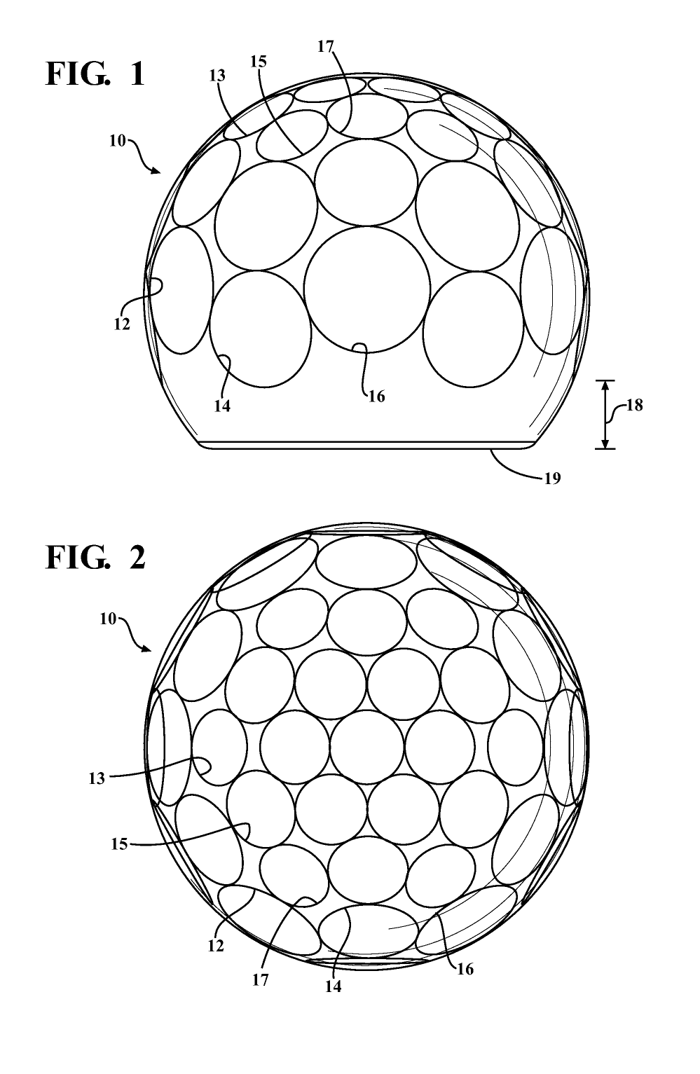

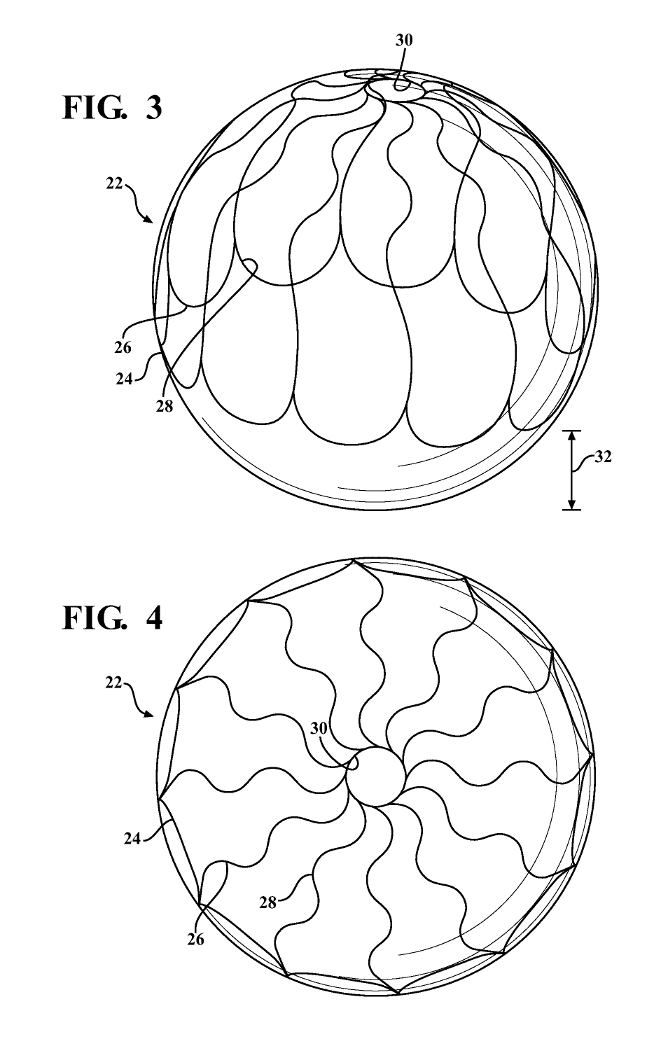

The above stated, FIGS. 1 and 2 present respective side and top view illustrations of a spherical end component 10 associated with a male joint implant and which exhibits a micro-groove pattern consisting of a plurality of edge communicating and non-overlapping circular channels (or profiles), such as including a first number of lower/outer periphery profiles 12, 14, 16, et seq. formed upon the spherical surface in combination with a second number of upper profiles 13, 15, 17 et seq. which are on average smaller in diameter than the lower/outer periphery profiles. As previously indicated, not shown is the provision of an integrally extending stem component (such as mounted to a reconditioned bone end so that the stem is received within its hollow interior).

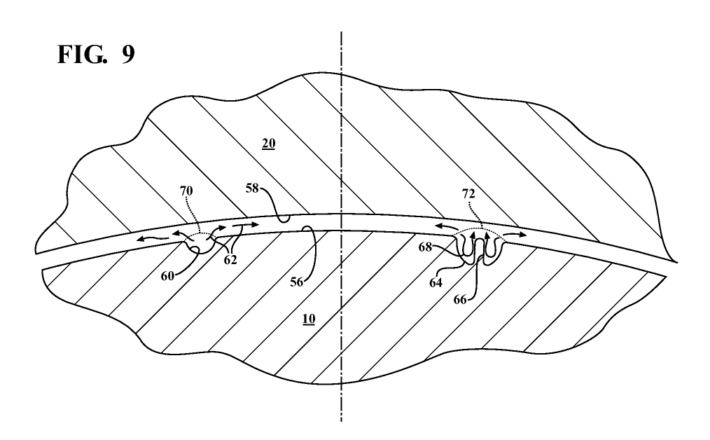

As depicted, the arrangement and diameter of the individual circular grooves or channels can vary. As further shown, the individual circular grooves intersect at various locations and which can facilitate the further distribution of lubricant across the opposing articulating surfaces established between the male/ball 10 and an associated female/cup 20 (see cutaway of FIG. 8) within which an over-center seating arrangement is established with the male joint defining ball 10.

Also depicted at 18 in FIG. 1 is an outer peripheral (less than maximum diameter) band extending from a substantially flattened base 19 of the male receiver to a height location less than a maximum diameter of the ball 10 and which (as understood by further reference to the illustration of FIG. 8) generally extends from a location at which a female cup receiver 20 with exposed annular end surface 19 is mounted in overlapping and circumferential seating fashion about the male ball 10. The dimension of the band 18 is such that it extends a predetermined location beyond the maximum circumference location of the ball 10 (as generally depicted at 21 in FIG. 8) and in order to retentively seat the male component in a determined articulating range. That said, it is envisioned and understood that the groove/pattern depicted can be configured across the spherical surface and up to any intermediate or bottom edge location of the male ball (this including extending to the actual bottom rim edge of the male ball). While not shown, it is also envisioned and understood that the micro-grooves or channels can be alternatively configured into the opposing concave surfaces of the female receiver (again at 20 in FIG. 7), as well as potentially incorporated into each of the male and female surfaces.

Referring now to FIGS. 3 and 4, a succeeding pair of side and top views are generally illustrated at 22 of a second micro-groove pattern defined upon a spherical exterior surface of a further configured ball joint component and which, as shown, consists of a plurality of undulating and overlapping channels 24, 26, 28, et seq., these being formed on a spherical surface of a male joint implant component according to a second non-limiting variant. The undulating channels can extend from an uppermost and circular groove depicted at 30 and, as further depicted at 32, a lowermost band or range can define a rim location associated with the male which is not configured with grooves (such as further again given that this portion of the ball corresponds generally with a projecting location beyond female seating cup), with it further understood that extending the micro grooves to a lower rim end of the ball could result in leakage of the fluid from the articulating joint interface.

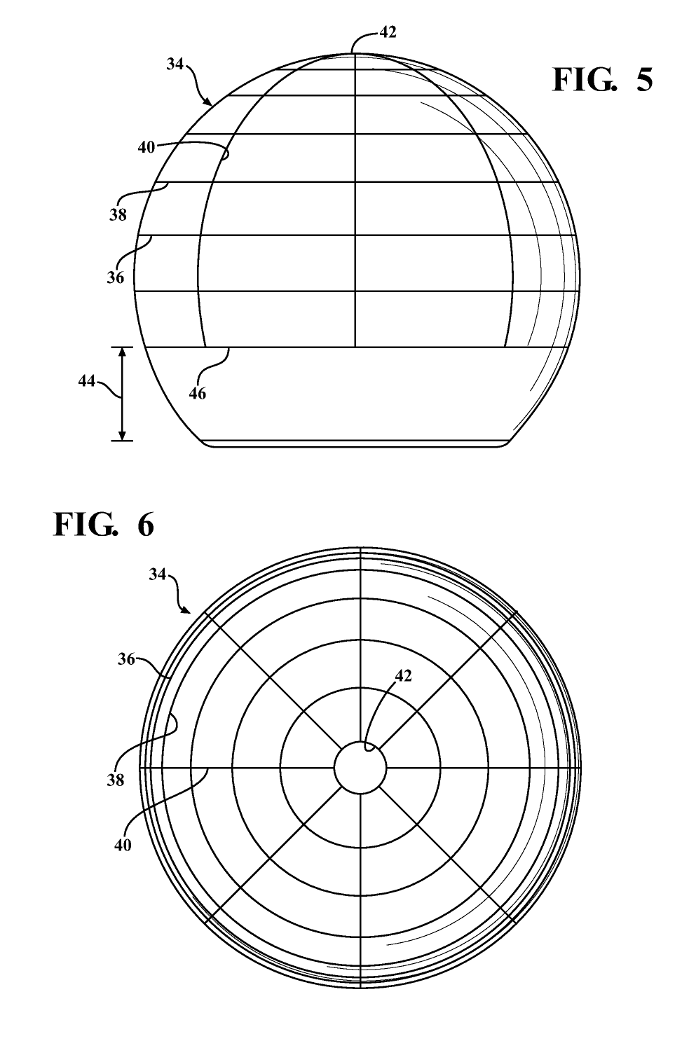

Illustrated generally at 34 in each of FIGS. 5 and 6 are side and top views of another spherical ball component exhibiting a third micro-groove pattern consisting of a plurality of grid shaped and intersecting channels, illustrated representatively at 36, 38, 40, et seq., and formed on a spherical surface of a male joint implant component according to a third non-limiting variant. As with the variant of FIG. 3, the grid shaped micro-channels can extend from an uppermost and circular groove 42 and facilitate the even dispersal of lubricant across the articulating interface defined between the ball and cup. A lower range (or band) is again referenced in FIG. 5 at 44 and which defines a lower rim end extending beyond a lower most encircling micro groove (at 46) and such as again defining a portion of the ball not encapsulated within the overlying cup and further not exhibiting any channels or grooves so as to deter a flow out loss of lubricant.

FIG. 7 presents a top view illustration generally at 48 of a spherical shaped male joint defining component (a corresponding side view not being shown as being largely repetitive and therefore unnecessary) exhibiting a further variation of micro-groove pattern consisting of a plurality of individually dispersed, isolated and localized circular channels (or again profiles) 50, 52, 54, et seq. formed in non-contacting fashion across a spherical surface of a male joint implant according to a fourth non-limiting variant. The purpose of the illustration of FIG. 7 is to present an example of one variation of microgroove pattern depicting individual and isolated circles (this contemplated to include any perimeter defining shape or polygonal configuration) which are intended to encourage maintaining segregated micro-volumes of lubricant at specified locations across the male/female articulating interface. The present inventions also contemplates additional designs in which the microgroove patterns can include either or both isolated/localized and intersecting grooves or channels in order to establish desired lubricant dispersal properties and/or profiles.

Having provided a description of a number of non-limiting surface profiles associated with a ball/cup articulating interface, and with successive reference to each of FIGS. 8 and 9, a description will now be provided on a more microscopic level of the cross sectional configuration or profile associated with each microgroove or channel. Referencing again FIG. 8, a side cutaway view is depicted of an articulating interface established between the male/ball 10 and a female/receiver 20, and within which the ball is seated.

As further illustrated in the enlarged partial view of FIG. 9, the male/female interface depicts a cross sectional profile associated with a pair of micro-grooves for facilitating micro-dispersal of synovial (as well as again any other natural or synthetic) lubricant. As shown, the male joint defining component 10 illustrates a first contact surface 56 which is opposed by a spatially dimensioned surface 58 associated with the female joint defining component 20. A first cross sectional profile is exhibited by a generally concave depression 60 within which segregates a micro-volume 62 of lubricant. A further undulating depression 64 (this further defining a central post 66 projecting upwardly from a lowermost trough location) is provided for supporting a further micro-volume 68 in a further dispersal fashion.

The arrangement and configuration of the individual channel profiles is designed to promote desired lubricant dispersal properties, such as in an effort to promote even coating. The two examples illustrated of the microgroove profiles are amount a potentially unlimited number configurations and which, when factoring in the opposing forces exerted by the spatially dimensioned surface 58, assist in promoting micro-dispersal of lubricant in an even fashion across the male/female articulating interface, such that the micro-volumes of lubricant are encouraged to seep in and out of the individual concave troughs or depressions (formed by profiles 60, 64, 66) to promote maintaining an even lubricant coating or film across the interface.

In this fashion, incidences of such as squeaking or other acoustic emissions are diminished or eliminated entirely. Such acoustic squeaking or other sounds are associated with prior ball bearing type ball and socket implants in which the interface maintains a constant smooth surface profile which dynamically degrades even dispersal of synovial fluid.

In operation, the various grooves/channels operate as reservoirs into which the synovial fluid or other lubricant may freely flow and pool. Naturally occurring forces associated with surface tension cause the synovial fluid/lubricant to “mound up” or create bubble profiles slightly above the lip defining edge of each profile (see further at 70 and 72 in phantom in FIG. 9).

As the opposing surface of the joint comes into contact with these channels, a layer of the synovial fluid is continually deposited on the bearing defined surface. The continuous application of such fluid thereby prevents incidences of vibration or friction from occurring, thereby eliminating the acoustic emissions or other squeaking sounds, this in addition to greatly reducing friction and associated wear along the joint zone.

As previously suggested, similar modifications can be incorporated into any orthopedic type hardware where a reduction in friction and wear is desired, this further including applications to the human spine, such as artificial spinal disc replacements and the like.

Having described my invention, other and additional preferred embodiments will become apparent to those skilled in the art to which it pertains, and without deviating from the scope of the appended claims.

I claim:

1. A joint replacement assembly, comprising:
a male component seating within a female component; and
a pattern of microgrooves defined in an articulating surface associated with at least one of the components, a volume of lubricant being maintained in an evenly distributed fashion across the articulating surface in order to provide at least one of reduced friction, increased wear life, and elimination of squeaking or acoustical emissions.

2. The invention as described in claim 1, said microgrooves further comprising a plurality of intersecting and enclosed profiles.

3. The invention as described in claim 1, said microgrooves further comprising a plurality of overlapping and undulating patterns.

4. The invention as described in claim 1, said microgrooves further comprising an intersecting grid pattern.

5. The invention as described in claim 1, said microgrooves further comprising a plurality of isolated profiles.

6. The invention as described in claim 1, further comprising said microgrooves exhibiting a concave depression cross sectional profile.

7. The invention as described in claim 6, further comprising a further plurality of said microgrooves exhibiting a central upward projection associated with said concave depression.

8. A joint replacement assembly, comprising:
a spherical end component seating within a cup shaped component; and
a pattern of microgrooves defined in an articulating surface associated with at least one of said components, a volume of lubricant entrained between said components and being maintained in an evenly distributed fashion across the articulating surface in order to provide at least one of reduced friction, increased wear life, and elimination of squeaking or acoustical emissions.

9. The invention as described in claim 8, said spherical end component exhibiting a flattened base surface from which an outer peripheral band extends to a location less than maximum diameter of the male receiver.

10. The invention as described in claim 8, said microgrooves further comprising a plurality of intersecting and enclosed profiles.

11. The invention as described in claim 8, said microgrooves further comprising a plurality of overlapping and undulating patterns.

12. The invention as described in claim 8, said microgrooves further comprising an intersecting grid pattern.

13. The invention as described in claim 8, said microgrooves further comprising a plurality of isolated profiles.

14. The invention as described in claim 8, further comprising said microgrooves exhibiting a concave depression cross sectional profile.

15. The invention as described in claim 14, further comprising a further plurality of said microgrooves exhibiting a central upward projection associated with said concave depression.

16. A joint replacement assembly, comprising:
a spherical end component seating within a cup shaped component;
a pattern of microgrooves defined in an articulating surface associated with at least one of said components and exhibiting any of a plurality of intersecting and enclosed profiles, a plurality of overlapping and undulating patterns, an intersecting grid pattern, and a plurality of isolated profiles; and
a volume of lubricant entrained between said components and being maintained in an evenly distributed fashion across the articulating surface in order to provide at least one of reduced friction, increased wear life, and elimination of squeaking or acoustical emissions.

17. The invention as described in claim 16, further comprising said microgrooves exhibiting a concave depression cross sectional profile.

18. The invention as described in claim 17, further comprising a further plurality of said microgrooves exhibiting a central upward projection associated with said concave depression.
